(19) United States
(12) Patent Application Publication
(10) Pub. No.: US 2008/0107815 A1
(43) Pub. Date: May 8, 2008

(54) Preparation Of Aqueous Dispersions Of Organopolysiloxanes

(75) Inventors: Otto Schneider, Burghausen (DE); Uwe Scheim, Coswig (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/936,294

(22) Filed: Nov. 7, 2007

(30) Foreign Application Priority Data
Nov. 8, 2006 (DE) 10 2006 052 729.1

(51) Int. Cl. C08L 83/06; B05D 3/00; C08G 77/06

(52) U.S. Cl. 427/387; 524/588; 528/12

(57) ABSTRACT

Aqueous dispersions of organopolysiloxanes are prepared by
(a) reacting organopolysiloxanes having condensable groups with silanes:

(R³O)₃SiCR²₂—Y (II)

or their hydrolyzates, where R² is hydrogen or a monovalent C₁₋₄ alkyl radical, R³ is a C₁₋₈ alkyl radical, and Y is —CH₂NHR⁴, —CH₂NR⁴₂ or

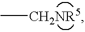

in the presence of water and emulsifier,
(b) adding an aqueous silica dispersion, optionally mixed with a silane of the formula (II),
(c) optionally adding an adhesion promoter, and
(d) optionally adding of further materials which do not take part in reaction (a), with the proviso that no metal-containing catalysts are used and that the organopolysiloxanes and silanes are used in such amounts that the organopolysiloxanes form elastomeric films insoluble in toluene on removal of water.

### BACKGROUND OF THE INVENTION

1. Field of the Invention

This invention relates to a process for preparing aqueous dispersions of organopolysiloxanes without the use of metal-containing catalysts. The present invention further relates to aqueous dispersions of organopolysiloxanes which form elastomers on removal of water, and to the use thereof as sealing and coating materials. The present invention further relates to elastomeric articles, in particular films, seals, coatings and overcoatings, produced from the aqueous dispersions of the invention.

2. Background Art

Emulsions of crosslinked silicones are known. Catalysts comprising (heavy) metal or metal-free catalysts are required for crosslinking the silicones as well as crosslinkers which are also employed. In some cases, inhibitors are also used to control reactivity and pot life in order that unwanted, premature gelling may be prevented. To be useful as sealing materials for applications in building construction, the cured products also must have a low modulus of elasticity.

Dispersions providing elastomeric films and prepared with the aid of a catalyst are described, for example in U.S. Pat. No. 5,001,187, US published application 2001/0027233 A1, and U.S. Pat. No. 4,894,412.

WO 2004/069899 describes the reaction of silanol-functional polysiloxanes in emulsion with γ-aminosilanes, for example 3-aminopropyltrimethoxysilane, in the presence of NaOH as a catalyst. After 6 to 8 hours of reaction at room temperature, the viscosity of the silicone polymer rises from 4000 to 6500 mPa·s. Despite the use of trifunctional silane, no crosslinked elastomer is obtained.

Waterborne RTV-1 mixtures are likewise admixed with metal-containing catalysts to obtain high reactivity, rapid film formation, etc as described for example in U.S. Pat. No. 5,861,459.

Metal-free aqueous RTV-1 dispersions are described in EP 828 794 A and EP 655 475 A1. They are obtainable using the three starting components:
(A) organopolysiloxanes comprising condensation-capable groups,
(B) (amine-free) organosilicon compounds acting as crosslinkers in that they have at least 3 crosslinking-reactive groups,
(C) organosilicon compound comprising basic nitrogen, more preferably the alkali metal siliconates of the compound, which are catalytically active.

### Component (C) confers a very high pH on the products, which presents difficulties in processing.

EP 739 947 A2 describes further metal catalyst-free aqueous RTV-1 dispersions. The catalysts which are involved are compounds which are attached to silanes via Si—N or Si—O—N bonds, and are released by hydrolysis. These RTV-1 dispersions additionally contain silica dispersions, stabilized by volatile amines, to improve the mechanical properties of the cured product. One disadvantage is that the catalytically acting compounds and the compounds used to stabilize the silicas, which are very odor intensive, are released as the dispersion dries, i.e., as it is being used.

DE 103 49 082 A1 describes aqueous polymeric dispersions which are exclusively stabilized by particles in the aqueous phase and do not contain any organic emulsifier. However, emulsions of this kind have the disadvantage that at the high solids contents required for use as sealing materials, they present curing problems to the extent that they do not form uninterrupted polymeric films.

DE 102004038148 A1 and its equivalent WO 2006/015740 A1 describe the preparation of high-viscosity silicones (10,000 to 50,000,000 mPa·s) in emulsion by reaction of silanol-terminated organopolysiloxanes with α-aminomethylalkoxysilanes. However, no elastomeric silicone films insoluble in toluene are obtained.

There are many applications for aqueous dispersions where catalysts, in particular metal-containing catalysts, and also solvents, are undesirable because of their toxicological, ecologically or otherwise unfavorable properties, such as impairing the stability of the emulsion in storage.

### SUMMARY OF THE INVENTION

An object of the present invention is to provide aqueous dispersions of organopolysiloxanes and also a simple process for their preparation, wherein the abovementioned disadvantages are avoided. A further object is to provide aqueous dispersions of organopolysiloxanes from which crosslinked organopolysiloxanes are obtained, and which form elastomeric films, particularly transparent films, upon removal of water. Yet further objects are to provide aqueous dispersions of organopolysiloxanes useful as sealing and coating materials, to provide dispersions of crosslinked organopolysiloxanes that are finely divided, stable and preferably pH-neutral (pH range about 5-9), and to provide dispersions of crosslinked organopolysiloxanes that are free or almost free of volatile organic compounds (VOCs). These and other objects are surprisingly achieved through preparation of dispersions containing an alkoxy or hydroxy-terminated organopolysiloxane polymer and an aminomethyl trialkoxysilane.

### DETAILED DESCRIPTION OF THE PREFERRED EMBODIMENT(S)

The present invention thus provides a process for preparing aqueous dispersions of organopolysiloxanes by

(a) reacting organopolysiloxanes (1) comprising condensation-capable groups and having the general formula

R¹O(R₂SiO)ₓR² (I)

where R is a monovalent hydrocarbyl radical of 1 to 18 carbon atoms,
R¹ is a hydrogen atom or an alkyl radical of 1 to 8 carbon atoms, preferably a hydrogen atom,
x is an integer from 10-1100, preferably 20-700, and more preferably 30-500, with silanes (2) of the general formula

(R³O)₃SiCR²₂—Y (II) or their hydrolyzates,

where R² is a hydrogen atom or a monovalent alkyl radical of 1 to 4 carbon atoms, preferably a hydrogen atom,
R³ is an alkyl radical having 1 to 8 carbon atoms per radical,
Y is a radical of the formula —NHR⁴, —NR⁴₂ or

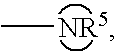

where R⁴ is a monovalent hydrocarbyl radical of 1 to 18 carbon atoms which optionally contains nitrogen and/or oxygen atoms,
R⁵ is a divalent hydrocarbyl radical of 3 to 12 carbon atoms which optionally contains nitrogen and/or oxygen atoms, in the presence of water (3) and emulsifier (4),

(b) adding an aqueous silica dispersion (5), if appropriate mixed with silanes (2) of the formula (II), either in the course of reaction (a) or after reaction (a), preferably after reaction (a),

(c) optionally adding adhesion promoters (6) either in the course of reaction (a) or after reaction (a), preferably after reaction (a), and

(d) optionally adding of further materials (7) which do not take part in reaction (a), either in the course of reaction (a) or after reaction (a), preferably after reaction (a),

with the proviso that no metal-containing catalysts are used and that the organopolysiloxanes (1) and silanes (2) are used in such amounts that the organopolysiloxanes form elastomeric films insoluble in toluene on removal of water (3).

The present invention further provides aqueous dispersions of organopolysiloxanes obtainable by

(a) reaction of organopolysiloxanes (1) comprising condensation-capable groups and having the general formula

R¹O(R₂SiO)ₓR¹ (I)

where R is a monovalent hydrocarbyl radical of 1 to 18 carbon atoms,
R¹ is a hydrogen atom or an alkyl radical of 1 to 8 carbon atoms, preferably a hydrogen atom,
   x is an integer from 10-1100, preferably 20-700, and more preferably 30-500, with silanes (2) of the general formula

(R³O)₃Si—CR²₂—Y (II) or their hydrolyzates,

where R² is a hydrogen atom or a monovalent alkyl radical of 1 to 4 carbon atoms, preferably a hydrogen atom,
R³ is an alkyl radical having 1 to 8 carbon atoms per radical,
Y is a radical of the formula —NHR⁴, —NR⁴₂ or

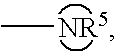

where R⁴ is a monovalent hydrocarbyl radical of 1 to 18 carbon atoms which optionally contains nitrogen and/or oxygen atoms,
R⁵ is a divalent hydrocarbyl radical of 3 to 12 carbon atoms which optionally contains nitrogen and/or oxygen atoms, in the presence of water (3) and emulsifier (4),

(b) addition of aqueous silica dispersions (5), if appropriate mixed with silanes (2) of the formula (II), either in the course of reaction (a) or after reaction (a), preferably after reaction (a),

(c) optionally addition of adhesion promoters (6) either in the course of reaction (a) or after reaction (a), preferably after reaction (a), and

(d) optionally addition of further materials (7) which do not take part in reaction (a), either in the course of reaction (a) or after reaction (a), preferably after reaction (a), with the proviso that no metal-containing catalysts are used and that the organopolysiloxanes (1) and silanes (2) are used in such amounts that the organopolysiloxanes form elastomeric films insoluble in toluene on removal of water (3).

In the process of the present invention, reaction (a) can be carried out not only before the emulsion is produced, but also by initially emulsifying the organopolysiloxane (1) which then reacts in the form of an emulsion with the silane (2).

The dispersions of the present invention contain precrosslinked organopolysiloxanes which, after removal of water, form elastomeric films containing crosslinked organopolysiloxanes comprising high molecular weight branched or dendrimerlike ultrabranched structures. No viscosity measurement is possible on these elastomeric films. The polymeric siloxane networks of the elastomeric films are typically insoluble in organic solvents such as toluene, although they may possibly swell therein, which for the purposes of this invention is likewise to be understood as insoluble. This is in contrast to uncrosslinked organopolysiloxanes which can also be highly viscous but for which a viscosity measurement is possible and which are soluble in organic solvents, such as toluene.

It is surprising that aqueous dispersions of crosslinked organopolysiloxanes are obtainable by this process because it is stated in A. Adima et. al., Eur. J. Org. Chem. 2004, 2582-2588 that α-aminomethyltrialkoxysilanes decompose in the presence of water to form SiO₂ and the corresponding methylated amine. Preferably, the dispersions of the present invention are aqueous suspensions or aqueous emulsions of crosslinked organopolysiloxanes.

The dispersions of the present invention form an elastic network of silicone as they dry, without addition of catalyst or change in pH. Preferably only two (mutually reacting) components are required to prepare the crosslinked organopolysiloxanes of the present invention: OR¹-terminated polyorganosiloxanes (1), and crosslinkers (2). These components preferably react with each other at room temperature. No metal-containing additional catalysts are required to support the reaction. The reaction further preferably proceeds in the neutral range, i.e., in the pH range of about 5 to 9, which results autogenously due to the components themselves. Moreover, the high reactivity means that there is no need for specific management of the chemical reaction, nor preferably for any heating.

The dispersions of the present invention are notable for their high stability in storage, even at elevated temperature, and for its high stability to shearing. The process of the present invention has the advantage that dispersions of high solids content and filler content can be obtained. The nonvolatiles content of the dispersion is about 30% to 99.9% by weight, preferably greater than 50% by weight, based on the total weight of the dispersion.

The process of the present invention does not utilize any metal-containing catalysts; that is, preferably no transition metals of transition group VIII of the periodic table and their compounds and no metals of main groups III, IV and V of the periodic table and their compounds are used. The elements C, Si, N, and P do not count as metals in this definition.

Examples of hydrocarbyl radicals R are alkyl radicals such as methyl, ethyl, n-propyl, isopropyl, 1-n-butyl, 2-n-butyl, isobutyl, tert-butyl, n-pentyl, isopentyl, neopentyl, and tert-pentyl; hexyl such as n-hexyl; heptyl such as n-heptyl; octyl such as n-octyl and isooctyl such as 2,2,4-trimethylpentyl; nonyl such as n-nonyl; decyl such as n-decyl; dodecyl such as n-dodecyl; octadecyl such as n-octadecyl; cycloalkyl such as cyclopentyl, cyclohexyl, cycloheptyl and methylcyclohexyl; alkenyl such as vinyl, 5-hexenyl, cyclohexenyl, 1-propenyl, allyl, 3-butenyl and 4-pentenyl; aryl such as phenyl, naphthyl, anthryl and phenanthryl; alkaryl such as o-, m-, p-tolyl, xylyl and ethylphenyl; and aralkyl such as benzyl, α-phenylethyl and β-phenylethyl. Preference for use as radicals R is given to methyl, ethyl, octyl and phenyl, with methyl and ethyl being particularly preferred.

Examples of alkyl radicals R¹ are the alkyl radicals recited above for R, having 1 to 8 carbon atoms, and examples of alkyl radicals R² are those of R having 1 to 4 carbon atoms, while preferred examples of alkyl radicals R³ are methyl and ethyl radicals.

Examples of hydrocarbyl radicals R, such as alkyl, cycloalkyl, aryl, alkaryl and aralkyl radicals, hold in full for hydrocarbyl radicals R⁴. Preferred examples of alkyl radicals R⁴ are methyl, ethyl, butyl, hexyl, and octyl radicals, and a preferred example of cycloalkyl radicals R⁴ is the cyclohexyl radical.

A preferred example of R⁵ is the radical of the formula —CH₂—CH₂—O—CH₂—CH₂—, and preferred examples of Y radicals are morpholino, piperazino, piperidino and cyclohexylamino radicals.

The process of the present invention preferably utilizes as organopolysiloxanes (1) those of the formula (I) where 25 to 100% and preferably 50 to 100% of all R¹ radicals are hydrogen atoms. Examples of organopolysiloxanes (1) are commercially available polydimethylsiloxanes having terminal silanol groups and polydimethylsiloxanes having terminal alkoxy groups. These dispersions can be prepared from one kind of organopolysiloxane (1) or different kinds of organopolysiloxane (1).

The organopolysiloxanes (1) preferably have viscosities in the range of 10 mPa—s to 1,000,000 mPa—s at 25° C., more preferably 50 mPa·s to 30,000 mPa·s at 25° C. and most preferably 100 mPa·s to 10,000 mPa.s at 25° C.

The present invention process for preparing the dispersion can utilize one kind of silane (2) or different kinds of silane (2). Preferably, the —CR²₂—Y radical in silane (2) of formula (II) is a radical of formula —CH₂—Y. Examples of —CR²₂—Y radicals in silane (2) are aminomethyl, methylaminomethyl, dimethylaminomethyl, diethylaminomethyl, dibutylaminomethyl, cyclohexylaminomethyl, morpholinomethyl, piperidinomethyl, piperazinomethyl, ((diethoxy-methylsilyl)methyl)cyclohexylaminomethyl, ((triethoxysilyl)methyl)cyclo-hexylaminomethyl, anilinomethyl, 3-dimethylaminopropylaminomethyl and bis(3-dimethylaminopropyl)aminomethyl.

Examples of silanes (II) are dibutylaminomethyltriethoxysilane, dibutylaminomethyltributoxysilane, cyclohexylaminomethyltrimethoxysilane, cyclohexylaminomethyltriethoxysilane, anilinomethyltriethoxysilane, morpholinomethyltriethoxysilane, morpholinomethyltrimethoxysilane, morpholinomethyltriisopropoxysilane, 3-dimethyl-aminopropylaminomethyl-trimethoxysilane, ethylcarbamoylmethyltrimethoxysilane, morpholinomethyl-tributoxysilane, morpholinomethyltrialkoxysilane, where the alkoxy radical is a C₁-C₄-alkoxy radical, in particular a mixture of methoxy and ethoxy, bis(dimethylaminopropyl)aminomethyltriethoxysilane, diisopropyl-aminomethyltriethoxysilane, piperazinomethyltriethoxysilane, piperidinomethyltriethoxysilane, bis(diethoxymethylsilylmethyl)cyclohexylamine, bis(triethoxysilylmethyl)cyclohexylamine, morpholinomethyltri(2-hydroxyethoxy)silane.

Preference is given to silanes (2) of formula (II) wherein the (R³O)-radical is an ethoxy group.

The silanes (2) of formula (II) may contain up to 30% by weight of difunctional silanes of formula

(R³O)₂RSiCR²₂—Y (III) or their hydrolyzates.

The silane of formula (III) has a chain-extending effect for organopolysiloxanes (1), but does not disrupt the crosslinking reaction of silane of formula (II) with the chain-extended organopolysiloxane (1). Crosslinked organopolysiloxanes in accordance with the present invention are obtained. The degree of crosslinking depends on the starting ratio of the equivalents of —OR³ in silane (2) of formula (II) to —OR¹ in organopolysiloxane (1) of formula (I).

The dispersions of the present invention are prepared from organopolysiloxane (1) and silane (2) by using silane (2) or its hydrolyzates preferably in amounts of at least 0.6 equivalent of —OR³, preferably at least 0.7 equivalent of —OR³, more preferably 0.6 to 2 equivalents of —OR³, yet more 0.65 to 1 equivalent of —OR³, and most preferably 0.7 to 0.99 equivalent of —OR³, per equivalent of —OR¹ in organopolysiloxane (1), where R¹ in (1) is preferably a hydrogen atom.

The crosslink frequency depends not only on the chain lengths of the organopolysiloxanes (1) but also on the stoichiometry of the mutually reacting SiOR¹ groups of organopolysiloxane (1) and the SiOR³ groups of silane (2). High degrees of crosslinking are achieved when equal numbers of the SiOR¹ groups of organopolysiloxane (1) and SiOR³ groups of silane (2) react with each other. Losses due to volatility or secondary reactions may for this purpose require a stoichiometric ratio other than 1.0:1.0. If desired, a stoichiometric excess of SiOR³ groups from silane (2) to SiOR¹ groups from organopolysiloxane (1) can be used. It was determined that, surprisingly, elastic films are obtainable even from a stoichiometric deficiency of SiOR³ groups from silane (2) to SiOR¹ groups from organopolysiloxane (1), for example 0.7:1.0.

The dispersions of the present invention are produced by intensive mixing of organopolysiloxanes (1) with silanes (2), water (3), emulsifiers (4), aqueous silica dispersions (5), if appropriate adhesion promoters (6) and if appropriate further materials (7). Production can be batchwise or continuously, as described for example in DE 102004023911 A or for that matter WO 2005100453.

Technologies for producing dispersions or emulsions of organopolysiloxanes are known. The intensive mixing and dispersing can take place in rotor-stator stirrers, colloid mills, high pressure homogenizers, microchannels, membranes, jet nozzles and the like, or ultrasonically. Homogenizing instruments and processes are described for example in ULLMANN'S ENCYCLOPEDIA OF INDUSTRIAL CHEMISTRY, CD-ROM edition 2003, Wiley-VCH, under the headword of “Emulsions”.

Although the silanes (2) are known to contain hydrolysis-sensitive groups, particularly when R³ is a hydrogen atom or a methyl or ethyl radical, surprisingly, crosslinked organopolysiloxanes are obtained even in the presence of water by reaction with two or more organopolysiloxanes (1).

The manner of mixing the components to produce the dispersions of the present invention can be performed in various orders. However, depending on the components (1), (2), (3), (4), (5) and if appropriate (6) and (7), there may be preferred procedures which should be examined in the individual case.

For example, components (1) and (2) can be premixed with each other, then the emulsifier(s) (4) added and thereafter the water (3) and the aqueous silica dispersion (5) and if appropriate further materials (6) and (7) can be incorporated. It is also possible to meter the components (1) and (2) and also (3) to (7) into the emulsifying apparatus in succession. In particular cases, it can be advantageous, for example owing to the siloxane viscosity or reactivity, to mix silane (2) with an organopolysiloxane (1) and thereafter to incorporate another organopolysiloxane (1), or vice versa, depending on what results in better rheological properties for processing the components.

In the case of very reactive silanes (2), it can be advantageous first to convert component (1) with emulsifier (4) and the water (3) into a stiff phase and thereafter to meter the silane (2) pure or diluted in an inert material (7) before, if appropriate, further dilution with water.

It is also possible to add silane (2) into the final emulsion of organopolysiloxanes (1) in order that the desired reaction and crosslinking of the organopolysiloxane (1) in the emulsion may thereby be achieved. The silane (2) may further be partially or completely hydrolyzed beforehand, by addition of water. To obtain VOC-free hydrolyzate of silane (2), the by-produced alcohol R³OH can be partially or completely removed by suitable known measures such as distillation, membrane processes or other separation processes.

The process of the present invention employs water (3) in amounts of preferably 0.1% to 70% by weight and more preferably 0.1% to 25% by weight, all based on the total weight of all ingredients of the dispersion.

Preferably, the process for producing dispersions can be carried out continuously. Preferably, the organopolysiloxanes (1) required for preparing the dispersion are prepared continuously and forwarded continuously to the emulsifying apparatus and, before emulsification, are mixed continuously with silanes (2), emulsifiers (4) and/or some of the water as dispersion medium (3), and this mixture is fed directly continuously to a first high-shear mixer and a viscous phase is formed in the mixer, the pressure and temperature downstream of the mixer being measured and closed-loop controlled such that a qualitatively high-value and very finely divided dispersion is produced. The aqueous silica dispersion (5), adhesion promoter (6) and further materials (7) can be added upstream or downstream of the first high-shear mixer. If appropriate, the emulsion downstream of the first high-shear mixer can be further diluted by admixture of water.

The process of the present invention may utilize as emulsifiers (4) any previously known, ionic and nonionic emulsifiers (not only individually but also as mixtures of different emulsifiers) by the use of which aqueous dispersions, in particular aqueous emulsions of organopolysiloxanes, are obtainable.

Examples of Anionic Emulsifiers are:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) or propylene oxide (PO) units.

2. Sulfonates, particularly alkyl sulfonates having 8 to 18 carbon atoms, alkylaryl sulfonates having 8 to 18 carbon atoms, taurides, esters and monoesters of sulfosuccinic acid with monohydric alcohols or alkylphenols having 4 to 15 carbon atoms; if appropriate, these alcohols or alkylphenols may also be ethoxylated with 1 to 40 EO units.

3. Alkali metal and ammonium salts of carboxylic acids having 8 to 20 carbon atoms in the alkyl, aryl, alkaryl or aralkyl radical.

4. Phosphoric partial esters and their alkali metal and ammonium salts, particularly alkyl and alkaryl phosphates having 8 to 20 carbon atoms in the organic radical, alkyl ether or alkaryl ether phosphates having 8 to 20 carbon atoms in the alkyl or alkaryl radical and 1 to 40 EO units.

Examples of Nonionic Emulsifiers are:

5. Polyvinyl alcohol still having 5 to 50% and preferably 8 to 20% of vinyl acetate units and a degree of polymerization in the range from 500 to 3000.

6. Alkyl polyglycol ethers, preferably those having 3 to 40 EO units and alkyl radicals of 8 to 20 carbon atoms.

7. Alkyl aryl polyglycol ethers, preferably those having 5 to 40 EO units and 8 to 20 carbon atoms in the alkyl and aryl radicals.

8. Ethylene oxide/propylene oxide(EO/PO) block copolymers, preferably those having 8 to 40 EO and/or PO units.

9. Addition products of alkylamines having alkyl radicals of 8 to 22 carbon atoms with ethylene oxide or propylene oxide.

10. Fatty acids having 6 to 24 carbon atoms.

11. Alkylpolyglycosides of the general formula R*—O-Zₒ, where R* is a linear or branched, saturated or unsaturated alkyl radical having on average 8-24 carbon atoms and Zₒ is an oligoglycoside radical having on average o=1-10 hexose or pentose units or mixtures thereof.

12. Natural materials and their derivatives, such as lecithin, lanolin, saponines, cellulose; cellulose alkyl ethers and carboxyalkylcelluloses whose alkyl groups each have up to 4 carbon atoms.

13. Linear organo(poly)siloxanes containing polar groups, containing in particular the elements O, N, C, S, P, Si, particularly those linear organo(poly)siloxanes having alkoxy groups with up to 24 carbon atoms and/or up to 40 EO and/or PO groups.

Examples of Cationic Emulsifiers are:

14. Salts of primary, secondary and tertiary fatty amines having 8 to 24 carbon atoms with acetic acid, sulfuric acid, hydrochloric acid and phosphoric acids.

15. Quaternary alkyl- and alkylbenzeneammonium salts, in particular those whose alkyl groups have 6 to 24 carbon atoms, particularly the halides, sulfates, phosphates and acetates.

16. Alkylpyridinium, alkylimidazolinium and alkyloxazolinium salts, in particular those whose alkyl chain has up to 18 carbon atoms, specifically the halides, sulfates, phosphates and acetates.

Useful Ampholytic Emulsifiers Include in Particular:

17. Amino acids with long-chain substituents, such as N-alkyldi(aminoethyl)glycine or N-alkyl-2-aminopropionic acid salts.

18. Betaines, such as N-(3-acylamidopropyl)-N,N-dimethyl-ammonium salts having a C₈-C₁₈-acyl radical and alkylimidazolium betaines.

Preference for use as emulsifiers is given to nonionic emulsifiers, in particular the alkyl polyglycol ethers recited above under 6. The constituent (4) can consist of one of the abovementioned emulsifiers or of a mixture of two or more of the abovementioned emulsifiers, it can be used in pure form or as solutions of one or more emulsifiers in water or organic solvents. The process of the present invention preferably utilizes the emulsifiers (4) in amounts of 0.01% to 60% by weight and more preferably 0.02% to 30% by weight, all based on the total weight of organopolysiloxanes (1) and silanes (2).

When the organopolysiloxane (1) or the silane (2) or the resulting crosslinked organopolysiloxane itself acts as an emulsifier, the addition of separate emulsifier (4) can be dispensed with.

The aqueous silica dispersion (5) used in the process of the present invention is preferably a dispersion of a hydrophilic or partially hydrophobicized silicon dioxide, produced by flame hydrolysis (fumed silica) or by precipitation in aqueous solution (precipitated silica) preferably characterized by a carbon content of 0% to 10% for the silicon dioxide and a BET surface area of 50-500 m²/g. Known hydrophobicization methods can be used for hydrophobicizing the silicon dioxide. The solids content of the aqueous silica dispersion is preferably in the range from 15% by weight to 80% by weight and more preferably in the range from 25% by weight to 60% by weight. The silica can also be conditioned/hydrophobicized shortly before or during the addition (b) of the silica dispersion, by adding organic amines, silanes or siloxanes, such as aminosilanes or aminosilicones.

It is preferable at this point to add silanes (2) which are in accordance with the present invention, in amounts of about 0.3% to 5.0% by weight, based on the total weight of the silica dispersion (5). Especially in the case of silica dispersions having a comparatively high solids content of 25% to 60% by weight, the addition of silanes (2) is advantageous. This provides transparent elastomers even when silica dispersions having high solids contents are used.

The process of the present invention adds aqueous silica dispersions (5) in such amounts that preferably 2% to 30% by weight and more preferably 5% to 20% by weight of silica, all based on the total amount of organopolysiloxanes (1) and silane (2), is present in the dispersion.

The process of the present invention may add adhesion promoters (6) in order that the adhesion of the elastomers obtained from the dispersions of the present invention to substrates to which they were applied may be enhanced. Any adhesion promoter known from the prior art, such as functional silanes, for example 3-aminopropyl-functional, 3-methacryloyloxypropyl-functional or 3-glycidoxypropyl-functional alkoxysilanes, and also copolymers comprising methacrylates and/or epoxides can be used.

Further examples of adhesion promoters are commercially available functionalized siloxanes, such as amine oils, for example amine oils having 3-(2-aminoethyl)aminopropyl functions or aminopropyl functions, epoxy-functionalized siloxanes such as, for example, glycidoxy-substituted polydimethylsiloxanes, or resins, for example silicone resins or epoxy resins, in which case the siloxanes partly contain silanol and also alkoxy groups, or latex dispersions such as, for example, SBR latex dispersions. The adhesion-promoting additives can be added either neat, as an aqueous solution or as an emulsion in water. The process preferably utilizes adhesion promoters (6) in amounts of preferably 0.1% to 3% and more preferably 0.3% to 1%, all based on the total amount of organopolysiloxanes (1) and silane (2) in the dispersion.

The dispersions can be prepared as dispersions of undiluted crosslinked organopolysiloxanes, but a dilution with organic solvents or low-viscosity oligomers/polymers is sometimes advisable for handling reasons.

Examples of further materials (7) which do not take part in reaction (a) and which can be added in the process of the present invention are water-immiscible liquids, such as toluene, technical grade benzine fractions and also aromatics-free hydrocarbon mixtures having boiling ranges between 250° C. to 400° C. or aromatics-containing hydrocarbons, for example dodecylbenzene or didodecylbenzene, and low-viscosity oligomers/polymers, preferably siloxanes, such as dimethylpolysiloxanes, and further silanes or silicones in the form of oils or resins. Useful further materials (7) include water-miscible liquids, such as alcohols, glycols or silicone- or non-silicone-containing emulsions or dispersions.

Examples of further materials (7) which do not take part in reaction (a) and which can be added in the process of the present invention are water-insoluble solids, such as nonreinforcing fillers, i.e., fillers having a BET surface area of less than 50 m²/g, for example powders of quartz, chalk, cristobalite, diatomaceous earth, calcium silicate, zirconium silicate, montmorillonites such as bentonites, zeolites, including molecular sieves such as sodium aluminosilicate, metal oxides such as aluminum oxide, zinc oxide, and mixed oxides thereof, and titanium dioxide, metal hydroxides such as aluminum hydroxide, barium sulfate, calcium carbonate, gypsum, silicon nitride, silicon carbide, boron nitride, glass powder, carbon powder, plastics powder, glass microballoons and plastics microballoons.

Examples of further materials (7) which do not take part in reaction (a) are fibers such as glass fibers, carbon fibers and ceramic fibers.

Further useful materials (7) include commercially available preservatives for dispersions, such as isothiazolinones, parabens or formaldehyde, or their aqueous formulations.

The emulsifying operation to produce the dispersions is preferably carried out at temperatures below 120° C., more preferably at 5° C. to 100° C. and even more preferably at 10° C. to 80° C. Temperature increase preferably comes about through input of mechanical shearing energy, which is needed for the emulsifying operation. The temperature increase is not needed to speed a chemical process. Furthermore, the process of the present invention is preferably carried out at the pressure of the ambient atmosphere, but can also be carried out at higher or lower pressures.

The process of the present invention has the advantage that it proceeds without addition of catalysts, in particular without addition of metal catalysts. The reaction of organopolysiloxane (1) with silane (2) preferably goes to completion within a few minutes to several hours, with methoxysilanes again reacting faster than ethoxysilanes. The condensation can be speeded by means of acids and bases, which is not preferred, however. The alcohols generated as condensation by-products in the course of the process of the present invention can remain in the product or else be removed, for example by vacuum distillation, membrane processes, or by extraction.

The average particle size measured in the dispersions by means of light scattering is in the range from 0.001 to 100 μm, preferably in the range from 0.002 to 10 μm, and the pH can vary from 1 to 14, preferably from 3 to 9 and more preferably from 5 to 9. The dispersions of the present invention are stable in storage.

The present invention provides for the use of the dispersions of the present invention as sealing or coating materials. To be useful as a sealing material, it is necessary that the cured products have a low modulus, preferably a 100% extension stress of less than 0.4 mPa. It has been surprisingly discovered that the process of the present invention, although proceeding from comparatively low molecular weight polymers, provides a simple way of obtaining low-modulus elastomers, which is normally not possible.

The present invention further provides shaped articles obtainable by removing water (3) from the dispersions, preferably emulsions, of the present invention. Preferably, water is removed by allowing the dispersions of the present invention to dry at a temperature of 1 to 200° C., preferably 5 to 150° C. and more preferably in the temperature range of 5 to 40° C. Skin-forming time is preferably 5 min to 40 min. Tack free time is preferably 30 min to 24 h. The shaped articles are elastomeric articles, such as elastic films or seals. The dispersions of the present invention have the advantage that transparent elastomers, such as elastic films, are obtained on removal of water.

The dispersions of the present invention can be used in the usual way as sealing materials between two identical or different substrates. Examples of such substrates are glass, aluminum, steel, concrete, PVC, PMMA, and polycarbonates. When used as a coating material, the compositions remain essentially on the surface of the substrate.

The present invention thus provides a process for producing elastic films, which comprises applying the aqueous dispersion of the present invention to a substrate and removing water. The application of the dispersions to the substrates can be effected in any suitable manner for preparing coatings from liquid materials, for example by dipping, spreading, casting, spraying, rolling, printing, for example by means of an offset gravure overcoating apparatus, knife or bar coating or by means of an airbrush.

The layer thickness on the substrate/fibers to be coated is preferably in the range from 0.01 to 10,000 μm and more preferably in the range from 0.1 to 100 μm. Examples of substrates coatable with the dispersions by the process of the present invention are artificial or natural stone, such as concrete, sand-lime brick, marble, and sandstone.

### Testing of Film Formation:

Film formation is tested by weighing that amount of emulsion into a 7 cm diameter aluminum dish which produces about 5 g of residue after drying. This will be an initial weight of about 10 g in the case of a 50% emulsion. The emulsion is distributed uniformly in the aluminum dish, if appropriate by addition of water of dilution. This sample is left to stand open in a fume hood at room temperature for about 24 h. A film about 1 mm in thickness forms and is tested for its solubility in toluene.

### Shore A Hardness:

Shore A hardness was determined to German Standard Specification DIN 53505 (as of August 2000).

### Tensile Strength, Breaking Extension and Modulus:

Tensile strength, breaking extension and modulus (stress at 100% extension) were determined to DIN 53504 (as of May 1994) on test specimens in the S2 shape. To be able to determine these values, the products were spread as a 2 mm thick film on a PTFE base. After 24 h of storage at 23° C. and 50% relative humidity, the films were detached from the base and hung up such that they were on all sides freely accessible to air, so that they were able to become fully cured in the course of a further 6 days at 23° C. and 50% relative humidity. The test specimens were subsequently die cut out of these films in accordance with the abovementioned standard.

### Skin Formation Time:

Skin formation time was determined by spreading out a sample of the paste and storing it at 23° C. and 50% relative humidity. Every 5 min the surface was touched with the index finger of the right hand to check whether a rubber-elastic skin has formed on the surface.

### Tack Free Time:

The tack free time is the time starting at which the surface of the test specimens used to determine the skin formation time feels dry and nontacky to the touch.

### EXAMPLE 1

In an Ultra-Turrax T 50 emulsifying apparatus (from Janke & Kunkel/IKA), 5 g of isotridecyl decaethoxylate, 85% in water, commercially available under the trade name of Lutensol TO 109 (from BASF) and 8 g of ion-free water are combined to prepare an emulsifier mixture which is admixed with 100 g of a freshly prepared homogeneous siloxane polymer/silane mixture consisting of 99.65 g of polydimethylsiloxanediol containing 1100 weight ppm of terminal OH groups, as siloxane (1), and 0.39 g of N-morpholinomethyltriethoxysilane (molar mass 263.4) as silane (2), by metered addition. This is followed by portionwise dilution with altogether 90.1 g of completely ion-free water to obtain a milky white emulsion having an average particle size of 309 nm. The solids content of the emulsion is 50.7%, the pH is 6.0. The emulsion is homogeneous and stable even after 6 months of storage at room temperature.

When 0.5 g of this emulsion is poured into 8 g of tetrahydrofuran, a precipitate of the crosslinked and THF-insoluble organopolysiloxane elastomer forms immediately. The precipitate does not redissolve within 24 h.

27 g of a 15% aqueous dispersion of a fumed silica (BET surface area 150 m²/g) are homogeneously mixed into 100 g of the emulsion. The silica dispersion is obtainable from Wacker Chemie AG under the designation of HDK® KD150. Evaporating the mixture gives, after a drying time of 24 h/25° C., a gel-like elastic transparent film which firmly adheres to glass or aluminum.

### EXAMPLES 2 to 4

Further emulsions are prepared similarly to Example 1, using the amounts reported in Table 1.

TABLE 1

| | | | Solids | | Particle | Film evaluation |
|---|---|---|---|---|---|---|
| | Siloxane | Silane | content | | Size | after drying |
| Example | (1) in g | (2) in g | (%) | pH | (nm) | 24 h/25° C. |
| 2 | 99.56 | 0.44 | 50.5 | 7 | 478 | very elastic, |
| | | | | | | transparent |
| 3 | 99.40 | 0.60 | 49.9 | 7 | 481 | elastic, |
| | | | | | | transparent |
| 4 | 99.22 | 0.79 | 50.5 | 6.5 | — | elastic, opaque |

The reported solids content, pH and the particle size are determined before addition of the silica dispersion. The solids content is determined at 150° C. to constant weight using a Mettler Toledo HR 73. Particle sizes are determined using a Coulter N4 plus.

The elasticity of the films produced from the emulsion (without addition of silica dispersion) decreases with increasing amount of silane (2) from Example 1 to Example 4.

The elastomeric film produced from the Example 3 dispersion is cut apart and placed in toluene for 24 h. The cut edges are afterwards still sharp. The film has swollen, but is not dissolved in toluene; that is, the siloxanes are in a crosslinked state. A 15% aqueous dispersion of a fumed silica (BET surface area 150 m²/g) is homogeneously mixed into each of the emulsions of Examples 2-4 at a rate of 27 g of dispersion per 100 g of emulsion. The silica dispersion is available from Wacker Chemie AG under the designation HDK® KD150. Allowing the dispersion to dry at room temperature gives an elastic film of higher transparency and strength than the film obtained from the silica-free emulsion. The silicone film is insoluble in toluene.

### Comparative test C1a-C1f (EP 828 794 A and EP 655 475 A1):

The procedure of Example 3 is repeated except that 0.60 g of morpholinomethyltriethoxysilane, the inventive silane (2), is replaced by the component reported in table 2:

### Comparison C1a:

0.60 g of vinyltrimethoxysilane (VTMO) as per Example 1 of EP 828 794 A.

### Comparison C1b:

0.34 g of vinyltrimethoxysilane (molar mass 148.2).

(0.34 g=1.1 equivalents of Si—OCH3 of vinyltrimethoxysilane based on 1 equivalent of SiOH of siloxane (1) similarly to Example 3).

### Comparison C1c:

0.60 g of α,ω-dimethoxypoly(N-(2-aminoethyl)-3-aminopropyl-methylsiloxane) as per Example 1 of EP 828 794 A.

### Comparison C1d:

0.60 g of a resin mixture as per Example 1 of EP 655 475 A1 consisting of 16 parts of organopolysiloxane resin of formula [(CH₃)₃SiO_{1/2}][SiO₂] having an average molecular weight of 2000 and an average ethoxy content of 2.1 percent by weight, based on the resin molecule and 17 parts of organopolysiloxane resin of formula [(CH₃)₂SiO]_{0.2}[(CH₃)SiO_{3/2}]_{0.8} having an average molecular weight of 3000 and an average ethoxy content of 2.6 percent by weight, based on the resin molecule.

### Comparison C1e:

Similarly to Comparison C1d except that KOH is added to the resin mixture and the pH is 11.

### Comparison C1f: 0.60 g of a 1:1 mixture of vinyltrimethoxysilane (VTMO) and α,ω-dimethoxypoly(N-(2-aminoethyl)-3-aminopropylmethylsiloxane) as per Example 1 of EP 828 794 A.

The results are summarized in table 2:

TABLE 2

| | | Replacement of silane | | | Appearance of dried | |
|---|---|---|---|---|---|---|
| | Siloxane | (2) | | | emulsion after | |
| Comparison | (1) in g | in g | by | pH | 24 h/23° C. | 7 days/23° C. |
| C1a | 99.40 | 0.60 | VTMO¹⁾ | 5 | oily, thin, | oily, thin, |
| | | | | | clear | clear |
| C1b | 99.40 | 0.34 | VTMO¹⁾ | 5 | oily, thin, | oily, thin, |
| | | | | | clear | clear |
| C1c | 99.40 | 0.60 | GF95-H²⁾ | 10 | oily, thin, | oily, thin, |
| | | | | | cloudy | cloudy |
| C1d | 99.40 | 0.60 | resin³⁾ | 5 | oily, thin, | oily, thin, |
| | | | | | cloudy | cloudy |
| C1e | 99.40 | 0.60 | KOH to | 11 | oily, thin, | oily, |
| | | | pH 11 | | cloudy | thicker, |
| | | | | | | cloudy |
| C1f | 99.40 | 0.60 | VTMO¹⁾ + GF95- | 9 | oily, thin, | oily, |
| | | | H²) | | cloudy | thicker, |
| | | | | | | cloudy |

¹⁾vinyltrimethoxysilane
²⁾GF95-H = α,ω-dimethoxypoly(N-(2-aminoethyl)-3-aminopropylmethylsiloxane)
³⁾resin mixture from Example 1 of EP 655 475 A1 (see description above under Comparison 1d))

None of the emulsions form a film on drying. The oily silicones remaining behind are soluble in toluene (tested as 20% solution in toluene), i.e., they are not crosslinked.

### Comparative Test 2:

The viscosity increase after mixing the components siloxane (1) and silane (2) as per Example 3, i.e., α,ω-dihydroxypolydimethylsiloxane with morpholinomethyltriethoxysilane, was measured. For comparison, morpholinomethyltriethoxysilane was replaced by the components reported in table 3, in C2a-C2f (similarly to the comparative experiments C1a-C1f) and again the increase in viscosity was measured. The results are summarized in table 3.

While the viscosity rises rapidly using the inventive components (1) and (2), has doubled after 2 hours, and is no longer measurable after just 5 hours because an elastomer has formed, the viscosity in the case of comparative tests C2a-C2f rises only very gradually and even 7 days later crosslinked elastomeric particles are not formed.

TABLE 3
Measurement of viscosity increase

| | | | | Viscosity at 23° C. measured with Brookfield [mPa · s] | | | | |
|---|---|---|---|---|---|---|---|---|
| | Siloxane | Replacement of silane (2) | | immediately | | | | |
| Comparison | (1) in g | in g | | after mixing | after 2 h | after 24 h | after 2 days | after 6 days |
| C2a | 99.40 | 0.60 | VTMO¹⁾ | 5410 | 5740 | 5680 | 5720 | 5810 |
| C2c | 99.40 | 0.60 | GF95-H²⁾ | 6100 | 6240 | 6200 | 6200 | 6390 |
| C2d | 99.40 | 0.60 | resin³⁾ | 5860 | 5980 | 5960 | 5950 | 6020 |
| C2e | 99.40 | 0.60 | resin³⁾ + KOH to | 5950 | 6530 | 7480 | 7960 | 9280 |
| | | | pH 11 | | | | | |
| C2f | 99.40 | 0.60 | VTMO¹⁾ + GF95- | 5810 | 6580 | 8710 | 12,650 | 36,700 |
| | | | H²⁾ | | | | | |
| similarly to | 99.40 | 0.60 | as per invention; | 350,000 | 736,000 | not | not | not |
| Example 3 | | | morpholinomethyl- | | | measurable, | measureable, | measurable, |
| | | | triethoxysilane | | | crosslinked, | crosslinked, | crosslinked, |
| | | | | | | elastic | elastic | elastic |

Siloxane (1) = polydimethylsiloxanediol containing 1100 weight ppm of terminal OH groups

### EXAMPLE 5

In an Ultra-Turrax T 50 emulsifying apparatus (from Janke & Kunkel/IKA), 2.5 g of isotridecyl decaethoxylate (Lutensol TO 109, from BASF), and 8 g of water are combined to prepare an emulsifier mixture which is admixed with 99 g of a freshly prepared homogeneous siloxane/silane mixture of 98.56 g of polydimethylsiloxanediol containing 1100 weight ppm of terminal OH groups as siloxane (1), and 0.44 g of N-morpholinomethyl-triethoxysilane as silane (2), by metered addition. This is followed by portionwise dilution with altogether 8.9 g of water to obtain a pastelike, nonrunning, milky white emulsion. The solids content of the emulsion is 86.3%.

This emulsion is homogeneously admixed with component (5), 32 g of a 25% aqueous dispersion of a fumed silica (BET surface area 300 m²/g). The silica dispersion is available from Wacker Chemie AG under the designation HDK® D3025. The emulsion paste is homogeneous and stable even after 8 months of storage at room temperature.

When the emulsion is evaporated at 25° C., it takes just 25 minutes for skin formation to occur, and after 5 hours a compact film is nearly completely formed. After 24 h/25° C. an elastic, translucent, nontacky film adhering to glass, paper or aluminum is obtained. The film is insoluble in toluene.

Measured physical properties are: elongation at break 680%, stress at 100% elongation 0.11 MPa.

The emulsion paste is useful as a joint-sealing material.

### EXAMPLE 6

In an Ultra-Turrax T 50 emulsifying apparatus (from Janke & Kunkel/IKA), 9.1 g of isotridecyl decaethoxylate (Lutensol TO 109, from BASF) and 29.2 g of water are combined to prepare an emulsifier mixture which is admixed with 361.6 g of a freshly prepared homogeneous siloxane/silane mixture formed from 360 g of polydimethylsiloxanediol as siloxane (1), and 1.6 g of N-morpholinomethyltriethoxysilane as silane (2), by metered addition. A pastelike, nonrunning, milky white emulsion is obtained. The solids content of the emulsion is 92.1%. The emulsion paste is homogeneous and stable even after 8 months of storage at room temperature.

434.0 g of the dispersion thus prepared are homogeneously admixed with component (5), 111.0 g of an aqueous, partially hydrophobicized silica dispersion of 30.6% solids content, prepared according to EP 1433749 A1, and 2.85 g of N-morpholinomethyltriethoxysilane. The solids content of the emulsion is 80.2% and the pH is 8.5. The total mixture is deaerated and filled into a cartridge, and is stable in storage for more than 6 months.

A film 2 mm thick is spread onto PTFE foil. When water is removed at 25° C., it takes just 15 minutes for skin formation to occur. The film is nontacky after 1 h. Measured physical properties were: elongation at break 549%, modulus at 100% elongation 0.22 MPa, Shore A hardness 13, tensile strength 0.89 MPa.

The emulsion paste is useful as joint-sealing material.

The silica-containing silicone film has a higher transparency and strength than the film obtained from the silica-free emulsion. The silicone film adheres to glass, paper or aluminum and is insoluble in toluene.

### EXAMPLE 7

A dispersion is prepared similarly to Example 1 by using the following components:

2.5 g of isotridecyl decaethoxylate (Lutensol TO 109, from BASF); 8 g of completely ion-free;

100.55 g of a siloxane/silane mixture, freshly prepared from 97.5 g of siloxane (1) (polydimethylsiloxanediol containing 740 weight ppm of terminal OH groups), 0.55 g of N-morpholinomethyltriethoxysilane as silane (2), additionally as component (6), 2.5 g of N-(2-aminoethyl)(3-aminopropyl)methyldimethoxysilane and 90.1 g of completely ion-free water.

A milky white emulsion is formed. The solids content of the emulsion is 52.7% and its pH is 8.5. The emulsion is homogeneous and stable even after 3 months of storage at room temperature.

100 g of the dispersion thus prepared are homogeneously admixed with component 5, 26 g of an aqueous, partially hydrophobicized silica dispersion of 30.6% solids content, prepared according to EP 1433749 A1, and 0.73 g of N-morpholinomethyltriethoxysilane. The solids content of the emulsion is 48%, the pH is 8.5. The total mixture is stable in storage for more than 8 months.

Drying at room temperature leaves an elastomeric, translucent silica-containing silicone film which is insoluble in toluene.

The material is useful as sealing material and had the following physical properties: skin formation time 15 min, tack free time 1 h, Shore A hardness 13, tensile strength 0.84 mPa, elongation at break 550%, stress at 100% elongation (modulus) 0.22 MPa.

### EXAMPLE 8

0.25 g of a 10% solution of sodium laurylsulfate in water and 3.3 g of ion-free water are foamed up by shaking using a Vortex Genius 3 (from IKA). With continued shaking, a mixture consisting of 46.5 g of polydimethylsiloxanediol containing 1100 weight ppm of terminal OH groups, as siloxane (1), and also 0.25 g of N-morpholinomethyltriethoxysilane as silane (2) is added, and emulsified in, a little at a time. After about 20 g addition of this mixture, the resulting emulsion turns viscid, and emulsification is continued with a low-shear vane stirrer until the entire siloxane/silane mixture has been incorporated. Thereafter, further water is added to adjust the water content to 12% by weight. The size of the emulsion droplets obtained is in the range from about 1 to 30 μm (determined by optical microscope). Then, as component (5), 15 g of an aqueous silica dispersion of 25% by weight solids content, prepared according to EP 1433749 A1, and 0.14 g of N-morpholinomethyltriethoxysilane are homogeneously incorporated. When the water has evaporated, a translucent, elastic, toluene-insoluble film has formed. The dispersion is useful as a sealant.

### Comparative Test C3:

Example 1 is repeated except that instead of the siloxane polymer/silane mixture used in Example 1, 100 g of a freshly prepared homogeneous siloxane polymer/silane mixture consisting of 99.65 g of polydimethylsiloxanediol containing 1100 weight ppm of terminal OH groups and 0.59 g of N-(2-aminoethyl)(3-aminopropyl)trimethoxysilane are added. This is followed by the identical dilution with water to obtain a milky white, homogeneous emulsion having an average particle size of 362 nm and a pH of 7. Thereafter, the silica dispersion is incorporated as in Example 1.

A 24 h/25° C. drying time leaves an opaque oil film, but not an elastic film, even after 7 days' drying time. The oil film is soluble in toluene.

### Comparative Test C4 as per DE 102004038148 A1:

In an Ultra-Turrax emulsifying apparatus T 50 (from Janke & Kunkel/IKA), 9.38 g of isotridecyl decaethoxylate (Lutensol TO 109, from BASF AG), 3.90 g of castor oil ethoxylate G 1300 (from Atlas) and 4.55 g of water are combined to prepare a stiff emulsifier mixture, which is admixed with 125.28 g of a freshly prepared homogeneous polymer/silane mixture of 124.63 g of polydimethylsiloxanediol containing 765 weight ppm of terminal OH groups and 0.86 g of N-morpholylmethylmethyldiethoxysilane, added by metering. This is followed by portionwise diluting with 106.65 g of water to obtain a stable emulsion having an average particle size of 275 nm. The silicone content of the emulsion is 50%.

After standing for 24 h/25° C. the emulsion is evaporated and the siloxane polymer is re-extracted with n-heptane to obtain, after evaporation of the solvent, a highly viscous polysiloxane having a viscosity of 3400 Pa.s (25° C.), which is soluble in toluene and hence uncrosslinked. The dispersion containing this highly viscous polysiloxane is not in accordance with the present invention.

### Comparative test C5:

85 parts by weight of the emulsion of Example 5, which contains no silica dispersion, are admixed with 15 parts by weight of a pulverulent, fumed, finely divided, hydrophilic silica (BET surface area: 150 m²/g). The emulsion which was previously in the form of a paste turns into a crumbly powder from which no coherent elastic film useful as a sealing material can be produced after a drying time of 4 hours/25° C.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing aqueous dispersions of organopolysiloxanes, comprising
(a) reacting organopolysiloxanes (1) comprising condensation-capable groups, and having the formula
R¹O(R₂SiO)ₓR₁ (I)
where
R is a monovalent hydrocarbyl radical of 1 to 18 carbon atoms,
R¹ is a hydrogen atom or an alkyl radical of 1 to 8 carbon atoms, preferably a hydrogen atom,
x is an integer from 10-1100, with silanes (2) of the general formula
(R³O)₃SiCR²₂—Y (II) or their hydrolyzates,
where R² is a hydrogen atom or a monovalent alkyl radical of 1 to 4 carbon atoms,
R³ is an alkyl radical having 1 to 8 carbon atoms per radical,
Y is a radical of the formula —NHR⁴, —NR⁴₂ or 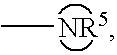
where R⁴ is a monovalent hydrocarbyl radical of 1 to 18 carbon atoms which optionally contains nitrogen and/or oxygen atoms,
R⁵ is a divalent hydrocarbyl radical of 3 to 12 carbon atoms which optionally contains nitrogen and/or oxygen atoms, in the presence of water (3) and emulsifier (4);
(b) admixing an aqueous silica dispersion (5), optionally mixed with silane(s) (2) of the formula (II), admixing taking place during reaction (a), after reaction (a), or both during and after reaction (a);
(c) optionally adding an adhesion promoter (6) during, following, or both during and following; and
(d) optionally adding of further materials (7) which do not take part in reaction (a), during, following, or both during and following, with the proviso that no metal-containing catalysts are used and that the organopolysiloxanes (1) and silanes (2) are used in amounts such that the organopolysiloxanes form elastomeric films insoluble in toluene on removal of water (3).

2. The process of claim 1, wherein
x is an integer from 20-700.

3. The process of claim 1, wherein
x is an integer from 30-500.

4. The process of claim 1 wherein silane (2) is used in amounts such that 0.6 to 2 equivalents of —OR³ are present per equivalent of —OR¹ in organopolysiloxane (1).

5. The process of claim 4 where R¹ is a hydrogen atom.

6. An aqueous dispersion of organopolysiloxanes, prepared by the process of claim 1.

7. An aqueous dispersion of organopolysiloxanes, prepared by the process of claim 2.

8. An aqueous dispersion of organopolysiloxanes, prepared by the process of claim 4.

9. An aqueous dispersion of organopolysiloxanes, prepared by the process of claim 5.

10. The dispersion of claim 1, which is a sealing or coating material.

11. A shaped article obtained by removing water (3) from the aqueous dispersion of claim 1.

12. The shaped article of claim 11 wherein the aqueous dispersions are allowed to dry at a temperature of 5 to 150° C.

13. The shaped article of claim 11 which is elastomeric.

14. The shaped article of claim 11 which is an elastic film which is transparent.

15. A shaped article of claim 11 which is a seal.

16. A process for preparing an elastic film, comprising applying an aqueous dispersion of claim 3 to a substrate, and removing water.
